(19) United States
(12) Patent Application Publication
(10) Pub. No.: US 2020/0250768 A1
(43) Pub. Date: Aug. 6, 2020

(54) INTELLIGENT SOYBEAN PRODUCTION MANAGEMENT METHOD AND SYSTEM

(71) Applicant: Agricultural Information Institute of CAAS, Beijing (CN)

(72) Inventors: Shiwei Xu, Beijing (CN); Jiayu Zhuang, Beijing (CN); Yongen Zhang, Beijing (CN); Shengwei Wang, Beijing (CN)

(73) Assignee: Agricultural Information Institute of CAAS, Beijing (CN)

(21) Appl. No.: 16/744,821

(22) Filed: Jan. 16, 2020

(30) Foreign Application Priority Data
Jan. 31, 2019 (CN) 201910113243.9

(51) Int. Cl. G06Q 50/02; G06N 3/08; G01D 21/02; A01G 22/40

(52) U.S. Cl. CPC G06Q 50/02; A01G 22/40; G01D 21/02; G06N 3/08

(57) ABSTRACT

The present invention discloses an intelligent soybean production management method and system. Obtaining time series data of each production element (moisture, a pesticide, and a chemical fertilizer) input in a soybean production process; obtaining time series data of a production environment index (light, soil temperature and humidity, and a soil nutrient), growth vigour, and a disease and pest situation of soybeans; training a long and short time memory recurrent neural network by using the time series data of the production environment index, the growth vigour, and the disease and pest situation of soybeans as input and by using the time series data of each production element input in the soybean production process as output; predicting input of each production element in the soybean production process; and managing soybean production according to the input of each production element predicted by using the long and short time memory recurrent neural network.

### TECHNICAL FIELD

The present invention relates to the soybean production management field, and in particular, to an intelligent soybean production management method and system.

### BACKGROUND

Rapid development of intelligent agricultural production has great significance to boom rural economy, optimize an industrial structure, and improve living standards of farmers. In the “Outline of the National Program for Long-and Medium-Term Scientific and Technological Development (2006-2020)”, “agricultural accurate operation and informatization” has been clearly included as an optimization subject. Therefore, establishing a modern soybean production management system by using a big data technology has great significance to agricultural modernization development of China and improvement of agricultural competitiveness.

### SUMMARY

An objective of the present invention is to provide an intelligent soybean production management method and system, so as to more conveniently and scientifically determine an input quantity of each production element in a soybean production process.

To achieve the above purpose, the present invention provides the following technical solutions:

An intelligent soybean production management method includes:

obtaining time series data of each production element input in a soybean production process, where the production element includes moisture, a pesticide, and a chemical fertilizer;

obtaining time series data of a production environment index, growth vigour, and a disease and pest situation of soybeans, where the production environment index includes light, soil temperature and humidity, and a soil nutrient, and the time series data is historical time series data obtained through statistics collection;

training a long and short time memory recurrent neural network by using the time series data of the production environment index, the growth vigour, and the disease and pest situation of soybeans as input and by using the time series data of each production element input in the soybean production process as output;

predicting input of each production element in the soybean production process by using a trained long and short time memory recurrent neural network; and

managing soybean production according to the input of each production element predicted by using the long and short time memory recurrent neural network.

Optionally, before the training a long and short time memory recurrent neural network, the method further includes:

conducting numeralization processing on an evaluation index in the time series data; and

processing the time series data to obtain data in a uniform format.

Optionally, in the process of training a long and short time memory recurrent neural network, an auxiliary neuron is added to an output layer of the long and short time memory recurrent neural network, so as to restrain and adjust output data, where an index corresponding to the auxiliary neuron includes a rate of return on input and a production-price elastic coefficient.

Optionally, in the training process, a weight of the long and short time memory recurrent neural network is determined in a feedback regulation manner.

Optionally, in the training process, the long and short time memory recurrent neural network uses a regular derivative for gradient solving, to obtain a weight and a bias of the long and short time memory recurrent neural network.

Optionally, segmentation is conducted on the time series data to obtain multiple time series data subsets, and obtained multiple subsets that are not adjacent to each other are used as a training set.

Optionally, a time series data corresponding to a time earlier than that corresponding to the training set is selected as a test set.

An intelligent soybean production management system includes:

a first historical data obtaining module, configured to obtain time series data of each production element input in a soybean production process, where the production element includes moisture, a pesticide, and a chemical fertilizer;

a second historical data obtaining module, configured to obtain time series data of a production environment index, growth vigour, and a disease and pest situation of soybeans, where the production environment index includes light, soil temperature and humidity, and a soil nutrient, and the time series data is historical time series data obtained through statistics collection;

a neural network model training module, configured to train a long and short time memory recurrent neural network by using the time series data of the production environment index, the growth vigour, and the disease and pest situation of soybeans as input and by using the time series data of each production element input in the soybean production process as output;

a prediction module, configured to predict input of each production element in the soybean production process by using a trained long and short time memory recurrent neural network; and

a production element input management module, configured to manage soybean production according to the predicted input of each production element.

Optionally, the system further includes:

a numeralization processing module, configured to conduct numeralization processing on an evaluation index in the time series data; and

a format unification module, configured to process the time series data to obtain data in a uniform format.

Optionally, the system further includes:

a neural network model output data adjustment module, configured to add an auxiliary neuron to an output layer of the long and short time memory recurrent neural network, so as to restrain and adjust output data, where an index corresponding to the auxiliary neuron includes a rate of return on input and a production-price elastic coefficient.

According to specific embodiments provided in the present invention, the present invention discloses the following technical effects: According to the intelligent soybean production management method and system that are provided in the present invention, big data related to soybean production is obtained, and an input quantity of each production element in a soybean production process is processed and predicted by using a deep learning method, so as to provide a basis for soybean production management. Because a relationship rule between input of each production element and other factors is used in the deep learning method, it is more scientific to predict an input result of each production element predicted by using the deep learning method. In addition, this method is more accurate and convenient than a conventional prediction method.

### BRIEF DESCRIPTION OF DRAWINGS

To describe the technical solutions in the embodiments of the present invention or in the prior art more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of an intelligent soybean production management method according to an embodiment of the present invention;

FIG. 2 is a structural drawing of a long and short time memory recurrent neural network according to an embodiment of the present invention; and

FIG. 3 is a structural drawing of an intelligent soybean production management system according to an embodiment of the present invention.

### DETAILED DESCRIPTION

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

An objective of the present invention is to provide an intelligent soybean production management method and system, so as to more conveniently and scientifically determine an input quantity of each production element in a soybean production process.

To make the foregoing objective, features, and advantages of the present invention clearer and more comprehensible, the present invention is further described in detail below with reference to the accompanying drawings and specific embodiments.

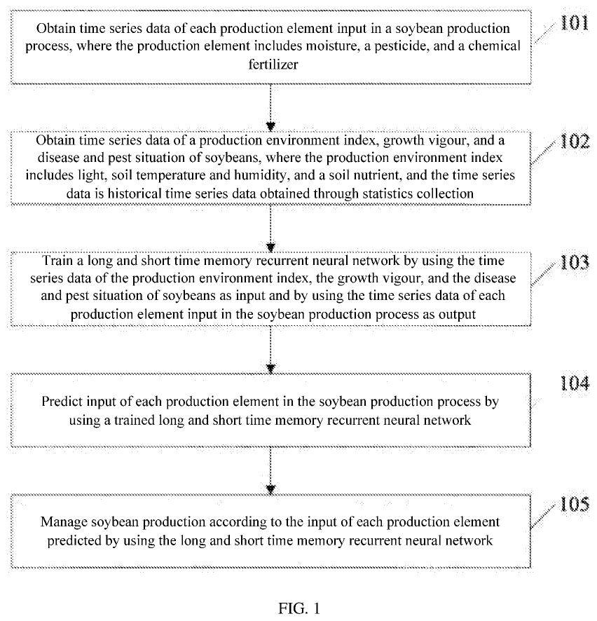

As shown in FIG. 1, an intelligent soybean production management method provided in the present invention includes the following steps:

Step 101. Obtain time series data of each production element input in a soybean production process, where the production element includes moisture, a pesticide, and a chemical fertilizer.

Step 102. Obtain time series data of a production environment index, growth vigour, and a disease and pest situation of soybeans, where the production environment index includes light, soil temperature and humidity, and a soil nutrient, and the time series data is historical time series data obtained through statistics collection.

Step 103. Train a long and short time memory recurrent neural network by using the time series data of the production environment index, the growth vigour, and the disease and pest situation of soybeans as input and by using the time series data of each production element input in the soybean production process as output. A soybean yield time series has a periodic characteristic, and a memory mechanism of the long and short time memory recurrent neural network is used, so as to relatively accurately predict an input requirement of each production element in a middle or short term soybean production process. The production element herein includes water, a pesticide, and a chemical fertilizer (further including a nitrogen fertilizer, a phosphorus fertilizer, and a potassium fertilizer).

Step 104. Predict input of each production element in the soybean production process by using a trained long and short time memory recurrent neural network.

Step 105. Manage soybean production according to the input of each production element predicted by using the long and short time memory recurrent neural network.

Before step 103 in the embodiment, the method further includes:

conducting numeralization processing on an evaluation index in the time series data, and

processing the time series data to obtain data in a uniform format.

Based on fusion of multiple heterogeneous data of soybean production and distribution links based on a combination of a public statistical database and survey data, numeralization and standardization processing are conducted on data about different time dimensions, different areas, different soybean production environment indexes (light, soil moisture, temperature, soil nutrients, and the like), growth vigour, a disease and pest situation, and the like, so as to form clear expressed time series data in a same format. Common diseases and insect pests of soybeans include downy mildew, a virus disease, Clanis bilineata, heartworm, Noctuidea, aphid, Cuscuta Chinensis, and another disease pest and weed.

Numeralization includes evaluation index numeralization (for example, very good: 100 points, good: 80 points, and relatively good: 70 points), and product grade numeralization (for example, level 1: 100 points, level 2: 80 points, and level 3: 60 points).

Standardization usually includes: a processing procedure according to numerical information and an information analysis application, the standardization processing of agricultural numerical information can be divided into two types: measurement unit unification and dimensionless processing.

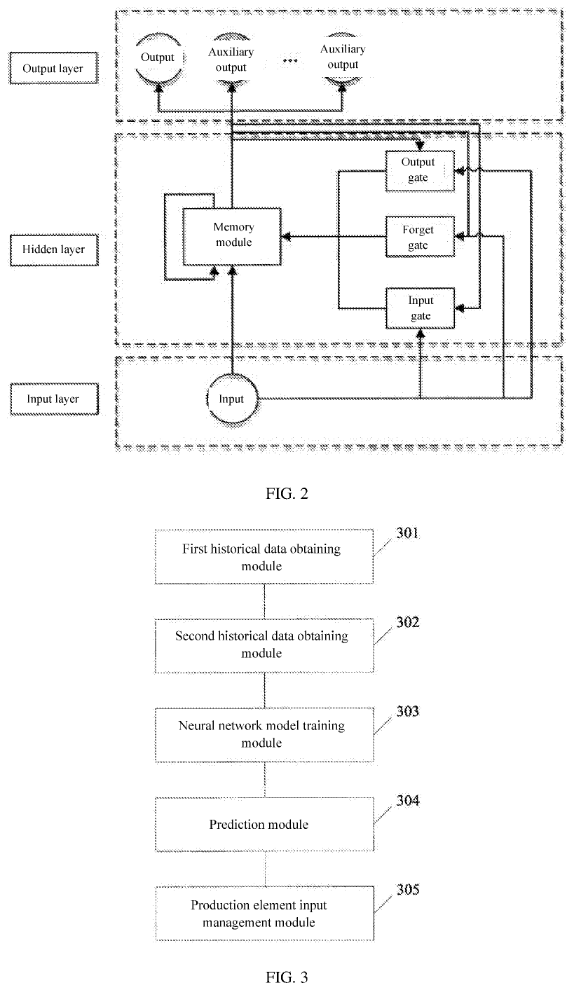

In an embodiment of the present invention, based on the foregoing embodiment, in a training process, an auxiliary neuron is added to an output layer of the long and short time memory recurrent neural network, as shown in FIG. 2, so as to restrain and adjust output data. By adding the auxiliary output neuron to the output layer and introducing a soybean growth mechanism characteristic and constraint, or introducing an economics theory or constraint, accuracy of model prediction can be improved. An index corresponding to the auxiliary neuron may include artificial empirical of input, an input-output ratio, a rate of return on input, yield elasticity, and the like.

A trained objective function c in a model can be expressed as follows:

$$ɛ = {ω ( {R}_{0} - {R}_{0}^{′} )}^{2} + {\sum }_{i = 1}^{n} {{ω}_{i} ( {R}_{i} - {R}_{i}^{′} )}^{2}$$

ω is an output error weight, R₀ is a training output result; R′₀ is an actual value of an output sample; Rᵢ is a training result of an auxiliary output; R′ᵢ is an actual value of the auxiliary output; and ωᵢ is auxiliary output weights, and satisfy the following formula:

$$ɛ = ω + {\sum }_{i = 1}^{n} {ω}_{i}$$

In the foregoing embodiment, a weight of the long and short time memory recurrent neural network may be determined in a feedback regulation manner, that is, weights of various parameters are calculated by using a backpropagation algorithm.

In an embodiment of the present invention, the long and short time memory recurrent neural network in the foregoing embodiment uses a regular derivative for gradient solving, to obtain a weight and a bias of the long and short time memory recurrent neural network. The long and short time memory recurrent neural network commonly uses a BPTT (Backpropagation Through Time) algorithm for gradient solving for calculating a weight and a bias of the model, and the algorithm may be regarded as an extension of a standard BP algorithm. However, a convergence speed of the BPTT algorithm is relatively slow, and therefore a gradient descent method is used in the BPTT algorithm for improvement in the present invention, and a regular derivative is used to replace a conventional partial derivative for search solution, so as to increase the convergence speed of the training algorithm.

In an embodiment of the present invention, based on the foregoing embodiment, different base period sample data is selected according to a time order and are divided into a training set and a test set, so as to ensure that a time corresponding to the training set is earlier than that corresponding to the test set. Specifically, segmentation is conducted on the time series data to obtain multiple time series data subsets, and obtained multiple subsets that are not adjacent to each other are used as a training set. A time series data corresponding to a time earlier than that corresponding to the training set is selected as a test set.

The present invention further provides an intelligent soybean production management system, as shown in FIG. 3, the system includes the following modules:

a first historical data obtaining module 301, configured to obtain time series data of each production element input in a soybean production process, where the production element includes moisture, a pesticide, and a chemical fertilizer;

a second historical data obtaining module 302, configured to obtain time series data of a production environment index, growth vigour, and a disease and pest situation of soybeans, where the production environment index include light, soil temperature and humidity, and a soil nutrient, and the time series data is historical time series data obtained through statistics collection;

a neural network model training module 303, configured to train a long and short time memory recurrent neural network by using the time series data of the production environment index, the growth vigour, and the disease and pest situation of soybeans as input and by using the time series data of each production element input in the soybean production process as output;

a prediction module 304, configured to predict input of each production element in the soybean production process by using a trained long and short time memory recurrent neural network; and

a production element input management module 305, configured to manage soybean production according to the predicted input of each production element.

The system may further include:

a numeralization processing module, configured to conduct numeralization processing on an evaluation index in the time series data;

a format unification module, configured to process the time series data to obtain data in a uniform format; and

a neural network model output data adjustment module, configured to add an auxiliary neuron to an output layer of the long and short time memory recurrent neural network, so as to restrain and adjust output data, where an index corresponding to the auxiliary neuron includes a rate of return on input and a production-price elastic coefficient.

According to the intelligent soybean production management method and system that are provided in the present invention, big data related to soybean production is obtained, and an input quantity of each production element in a soybean production process is processed and predicted by using a deep learning method, so as to provide a basis for soybean production management. Because a relationship rule between input of each production element and other factors is used in the deep learning method, it is more scientific to predict an input result of each production element predicted by using the deep learning method. In addition, this method is more accurate and convenient than a conventional prediction method.

Each embodiment of the present specification is described in a progressive manner, each embodiment focuses on the difference from other embodiments, and the same and similar parts between the embodiments may refer to each other. For a system disclosed in the embodiments, since it corresponds to the method disclosed in the embodiments, the description is relatively simple, and reference can be made to the method description.

Several examples are used for illustration of the principles and implementation methods of the present invention. The description of the embodiments is used to help illustrate the method and its core principles of the present invention. In addition, those skilled in the art can make various modifications in terms of specific embodiments and scope of application in accordance with the teachings of the present invention. In conclusion, the content of this specification shall not be construed as a limitation to the invention.

What is claimed is:

1. An intelligent soybean production management method, comprising:
obtaining time series data of each production element input in a soybean production process, wherein the production element comprises moisture, a pesticide, and a chemical fertilizer;
obtaining time series data of a production environment index, growth vigour, and a disease and pest situation of soybeans, wherein the production environment index comprises light, soil temperature and humidity, and a soil nutrient, and the time series data is historical time series data obtained through statistics collection;
training a long and short time memory recurrent neural network by using the time series data of the production environment index, the growth vigour, and the disease and pest situation of soybeans as input and by using the time series data of each production element input in the soybean production process as output;
predicting input of each production element in the soybean production process by using a trained long and short time memory recurrent neural network; and
managing soybean production according to the input of each production element predicted by using the long and short time memory recurrent neural network.

2. The intelligent soybean production management method according to claim 1, wherein before the training a long and short time memory recurrent neural network, the method further comprises:
conducting numeralization processing on an evaluation index in the time series data; and
processing the time series data to obtain data in a uniform format.

3. The intelligent soybean production management method according to claim 1, wherein in the process of training a long and short time memory recurrent neural network, an auxiliary neuron is added to an output layer of the long and short time memory recurrent neural network, so as to restrain and adjust output data, wherein an index corresponding to the auxiliary neuron comprises a rate of return on input and a production-price elastic coefficient.

4. The intelligent soybean production management method according to claim 1, wherein in the training process, a weight of the long and short time memory recurrent neural network is determined in a feedback regulation manner.

5. The intelligent soybean production management method according to claim 1, wherein in the training process, the long and short time memory recurrent neural network uses a regular derivative for gradient solving, to obtain a weight and a bias of the long and short time memory recurrent neural network.

6. The intelligent soybean production management method according to claim 1, wherein segmentation is conducted on the time series data to obtain multiple time series data subsets, and obtained multiple subsets that are not adjacent to each other are used as a training set.

7. The intelligent soybean production management method according to claim 6, wherein a time series data corresponding to a time earlier than that corresponding to the training set is selected as a test set.

8. An intelligent soybean production management system, comprising:
a first historical data obtaining module, configured to obtain time series data of each production element input in a soybean production process, wherein the production element comprises moisture, a pesticide, and a chemical fertilizer;
a second historical data obtaining module, configured to obtain time series data of a production environment index, growth vigour, and a disease and pest situation of soybeans, wherein the production environment index comprises light, soil temperature and humidity, and a soil nutrient, and the time series data is historical time series data obtained through statistics collection;
a neural network model training module, configured to train a long and short time memory recurrent neural network by using the time series data of the production environment index, the growth vigour, and the disease and pest situation of soybeans as input and by using the time series data of each production element input in the soybean production process as output;
a prediction module, configured to predict input of each production element in the soybean production process by using a trained long and short time memory recurrent neural network; and
a production element input management module, configured to manage soybean production according to the predicted input of each production element.

9. The intelligent soybean production management system according to claim 8, wherein the system further comprises:
a numeralization processing module, configured to conduct numeralization processing on an evaluation index in the time series data; and
a format unification module, configured to process the time series data to obtain data in a uniform format.

10. The intelligent soybean production management system according to claim 8, wherein the system further comprises:
a neural network model output data adjustment module, configured to add an auxiliary neuron to an output layer of the long and short time memory recurrent neural network, so as to restrain and adjust output data, wherein an index corresponding to the auxiliary neuron comprises a rate of return on input and a production-price elastic coefficient.
